(19) United States
(12) Patent Application Publication
(10) Pub. No.: US 2009/0257635 A1
(43) Pub. Date: Oct. 15, 2009

(54) SYSTEM FOR DEFINING VOLUMES OF INTEREST WITH REFERENCE TO ANATOMICAL FEATURES

(76) Inventors: SIMON HARVEY, Royal Leamington Spa (GB); TINA MANOHARAN, Witney (GB); VEIT ULRICH BORIS SCHENK, Mullheim (DE); KIMBERLEY ANE WHITEAR, Oxford (GB); THOMAS GEORGE WRIGHT, Oxford (GB)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/389,585

(22) Filed: Feb. 20, 2009

(30) Foreign Application Priority Data
Feb. 20, 2008 (GB) 0803064.5

(51) Int. Cl. G06K 9/00

(52) U.S. Cl. 382/131

(57) ABSTRACT

In a system and method for dividing a medical scan into regions to which features of interest may be assigned, region boundaries are defined with reference to anatomical landmarks and are presented to the physician along with the scan so that it is immediately apparent in which region a feature lies.

### BACKGROUND OF THE INVENTION

1. Field of the Invention

The present invention is concerned with processing of digital images, for example the results of medical scans such as Positron Emission Tomography. In particular, the invention is concerned with defining regions in a three dimensional image with a view to specifying a region in which a feature of interest in the image lies.

2. Description of the Prior Art

In the TNM-staging (Tumor, Node, Metastases) of lung cancer, the N-stage assesses the spread of metastases through the lymphatic system. The objective for the clinician is to determine whether the tumor has started to spread via the lymphatic system and, if so, to determine where.

Currently, the position of any affected lymph node is described as follows:

In a CT scan, which provides structural (anatomical) information about a subject, the mediastinum can be partitioned into a number of regions known as ‘stations’. These stations and their boundaries are defined in a widely used standard [AJCC1997: CIF Mountain and CM Dresler, Regional lymph node classification for lung cancer staging, Chest 1997; 111; 1718-1723] and are intended to make the tagging more systematic. This standard contains a schematic diagram of the mediastinum showing possible lymph-nodes and some short textural descriptions describing the landmarks necessary for delineating the stations. Any particular lymph node belongs to exactly one station, meaning that it is theoretically possible to label each lymph-node with its station number. However, setting the station boundaries is a difficult problem, even for an experienced radiologist, as the identification of these landmarks and the precise delineation are often ambiguous.

In a PET scan, where there is very little anatomical information, affected lymph-nodes are listed along with measurements such as uptake, size and relation of the location to an approximate position in the body. Any reporting done on a PET alone will lack the necessary information for staging and treatment, which relies on anatomical information.

The information about the location of the metastasized lymph node (relative to the primary tumor) is used for both staging and treatment (surgery, chemotherapy, palliative care).

Currently, the typical workflow for analysis of CT scans is

1) the radiologist views a thoracic CT axial slice by axial slice and identifies potentially affected lymph nodes;

2) once they have identified a candidate lesion, the next task is to identify the corresponding station label. For this, the radiologist must:

a) identify a number of individual anatomical landmarks for candidate stations

b) build a 3D representation (mentally) of the regions delimited by these landmarks (or planes which intersect these landmarks) and

c) decide which of the candidate stations the identified lymph-node belongs to.

A number of difficulties are associated with this task.

First, the landmarks are typically not visible in the same slice. As a result, in practice, the user scrolls backwards and forwards through a number of neighboring axial slices until they have identified the exact location of the landmark. This process is then repeated for the other landmarks.

Second, constructing a three dimensional representation of the region and the exact boundaries of this region (station) in each axial slice is a very difficult task. The difficulty is increased by the fact that there are fourteen stations with fairly complex definition, some of which consists of fairly disjointed sub-stations.

Third, the AJCC standard is a rather simplistic description and assumes significant anatomical knowledge. Whilst the illustration in the AJCC standard implies a simplified 2D representation of the problem (i.e. the mediastinum is split into regions which can be drawn as lines on a sheet of paper, as shown in FIG. 2) in reality the mediastinum has to be split into a number of complex 3D regions, as defined in the AJCC standard.

Fourth, the process must be repeated for each candidate lymph node (although it may be faster to perform once the specific anatomical landmarks have been found).

The overall process may take anywhere between 30 and 60 minutes and in practice, many radiologists resort not to reporting the station but only a rough region in which the affected lymph-node is located.

There are no automated tools available which assist with this problem.

### SUMMARY OF THE INVENTION

An object of the present invention is to provide an automatically operating method and apparatus that divide a scan into a series of partitions.

The above object is achieved in accordance with the present invention by a method and an apparatus for dividing a scan into a series of partitions, wherein a first estimate of predefined partition boundaries of the scan is automatically electronically placed on the scan, the partition boundaries are updated in accordance with the locations of key anatomical landmarks derived from the scan, and an image of the subject is displayed that includes data representative of the updated partition boundaries.

The invention also encompasses a computer-readable medium encoded with programming instructions that cause a processor to operate as described above in accordance with the present invention.

### BRIEF DESCRIPTION OF THE DRAWINGS

FIG. 1 schematically shows the stations of the human mediastinum as defined by the AJCC standard.

FIG. 2 shows schematically an apparatus suitable for implementation of the invention.

### DESCRIPTION OF THE PREFERRED EMBODIMENTS

The invention comprises a software tool that provides a graphical representation of regions of an image such as AJCC stations applied to a patient's CT scan.

This representation is, in effect, a labeling of the regions (stations) e.g. the boundaries of each station are defined, allowing for example a color coding to be applied to the image with each station having a different colored label. In practice, the clinician need only note the label in order to determine in which station a particular lymph node is located.

An object of the invention is to assist the clinician in performing step 2) of the workflow described previously. Step 1) must be performed first although the necessary functionality could be provided by the same tool.

In its most basic form, the invention overlays a number of planes on the standard orthogonal views of the CT scan and the user can then manipulate these (rotation and translation in any of the orthogonal views) to refine the partitioning applied to the particular patient being studied. No account of the image data is taken during this step and it is up to the user to position each plane manually.

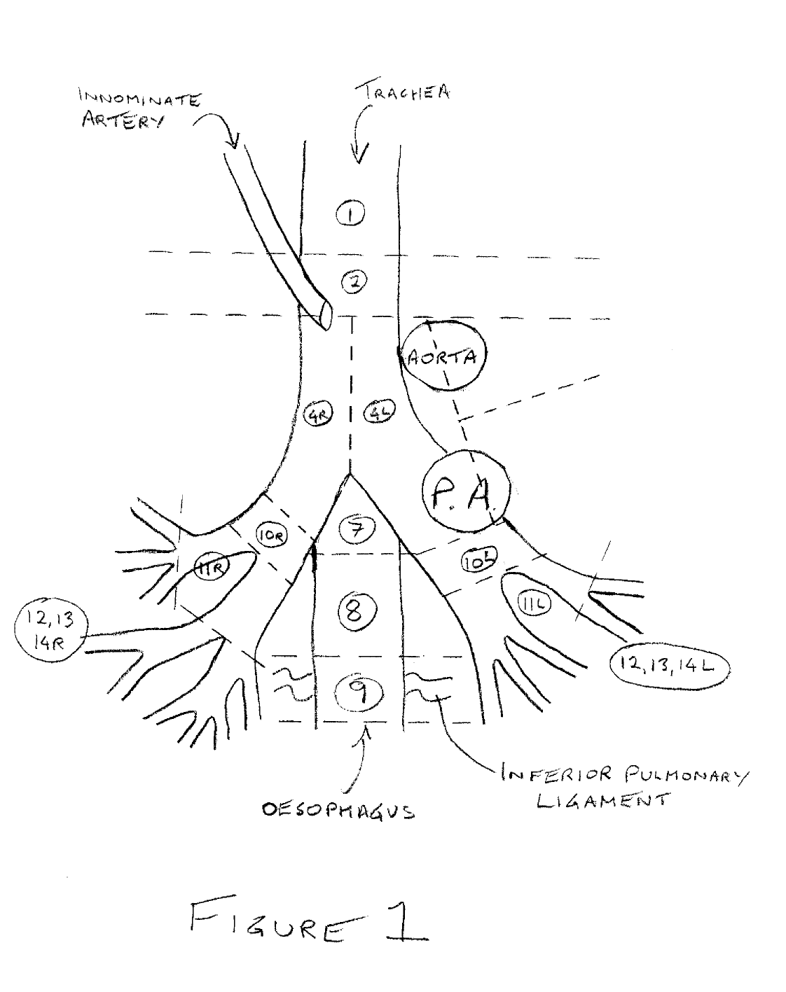

In a more sophisticated embodiment, constraints are applied to the positions that can be assigned to the planes in order to ensure that the resulting segmentation is always valid. For example, in FIG. 1, the station labeled 2 lies between two planes, the lower of which defines the top of stations 4R, 4L. Hence a sensible constraint would be to ensure that these two planes cannot be swapped over.

A number of techniques are available for applying such constraints, for example restricting the range of values which the normal vector to the plane can have (which in turn restricts the angle of the plane) or indicating that the intersection of two planes must lie on a given side of a third plane.

Although the initial position of the planes defining the partitioning need only be consistent with the constraints, (e.g. a ‘standard’ positioning could be applied to all new scans), this initial position can be improved by using features identified from the image (either manually or automatically). As an example, consider that the ‘standard’ positioning is created on a single scan where the position of the carina and the top of the aorta (on the same coronial slice) are known.

If the carina and top of aorta (on the same coronal slice) are now identified on a new patient's scan, it is possible to apply a transformation to the standard position of the planes to align the carina, and scale the positions according to the distance between the carina and top of the aorta, for example. The positions of the planes are then much more likely to be in approximately the correct position than in the first fully manual method, although of course variations in anatomy between patients are likely to mean that manual adjustment will still be required for most planes.

A more advanced technique for positioning the planes is based around automatically detecting several landmarks in the patient's CT scan. For example, the bottom of station 2 is defined in the AJCC standard to be a “horizontal line drawn tangential to the upper margin of the aortic arch”, and the top of station 2 is defined to be a “horizontal line at the upper rim of the brachiocephalic (left innominate) vein where it ascends to the left, crossing in front of the trachea at its midline”. Thus, if the crossing point of the innominate artery with the trachea and the top of the aortic arch were detected as landmarks from the CT scan, these points could be used accurately to position the boundaries of station 2.

A preferred technique for identifying landmarks of interest is based on use of an atlas. First the patient CT scan is registered to a pre-segmented atlas. The approximate location of the various organs thus derived is then used to initialize regions specific segmentation algorithms to refine the segmentation of the main vessels (aorta and pulmonary artery) and the airways. In addition to the segmentation of the structure, the centre line and branch points are also calculated, which in turn are then used to derive the required landmarks.

More generally, other detected features of the CT scan can be used to generate landmarks, for example the position of the innominate artery.

Although the planes define a partitioning of a patient's CT scan, there are several regions within the scan that cannot contain lymph nodes, for example the inside of the airways, the inside of the vessels and the air within the lungs. It is possible to identify such structures by applying segmentation algorithms to the patient's CT scan, and once this segmentation has been computed, remove the corresponding regions from the display.

Alternatives to using segmentation for detecting the landmarks for initializing the stations include model-based or statistical methods (or a combination thereof) feature detectors.

Such detectors are typically trained on either a model (placed using registration of the atlas to the patient CT) or a local grey value (or derived feature) distributions. These distributions can be learned from a large corpus of pre-segmented CT.

Thus, rather than first registering the patient CT to an atlas and then assuming that all organs overlap, it is possible to build feature detectors that find the landmarks of interest.

Rather than using planes to define the partitioning, it is possible to use other representations. One such example would be a cylinder around the main organs (such as the trachea or the aorta). This cylinder could be warped to follow the overall shape of the organ.

A further alternative is to use implicit surfaces as opposed to explicit surfaces (such as planes) but see below. An example of an implicit surface would be the decision boundary of a support-vector machine. This technique uses a large corpus of training data to learn the best boundary between stations, This ‘best’ boundary can then be reconstructed and displayed on screen.

Nevertheless, there are several advantages associated with using planes:

1. the AJCC standard is described in terms of planes. The clinician can hence easily compare the output of the algorithm with the standard. If the station boundaries are not planar, such comparison is no longer possible.

2. planes are straightforward to manipulate in three dimensions. This means that they can be translated and rotated to fit the underlying anatomy. With non-planar surfaces, this interaction is significantly more complex and non-intuitive.

3. In the case of implicit surfaces, one has to rely on the accuracy of the algorithm and the quality of the data that was used to compute the decision boundaries. If the algorithm encounters a case which is significantly different from the training data, then the overall output will be incorrect, However quality control is very difficult, as the user has no means of checking whether this is a case that is ‘covered’ by the training data. In the case of straight planes it is more apparent to the user when a plane is located incorrectly.

One of the major benefits of the invention is that the physician reading the PET now has access to a detailed labeled anatomical reference frame (the stations).

Although one might use a fused image to overlay the PET on the CT, the physician reading the PET is typically not as familiar with the AJCC standard as a radiologist specializing in thoracic CT would be. The stations overlaid on the PET hence provide new information for reporting not otherwise available.

In practice we assume that the CT and PET volumes are co-registered. This may be either a PET-CT pair of volumes, or independent PET and CT algorithms which are co-registered using an appropriate algorithm.

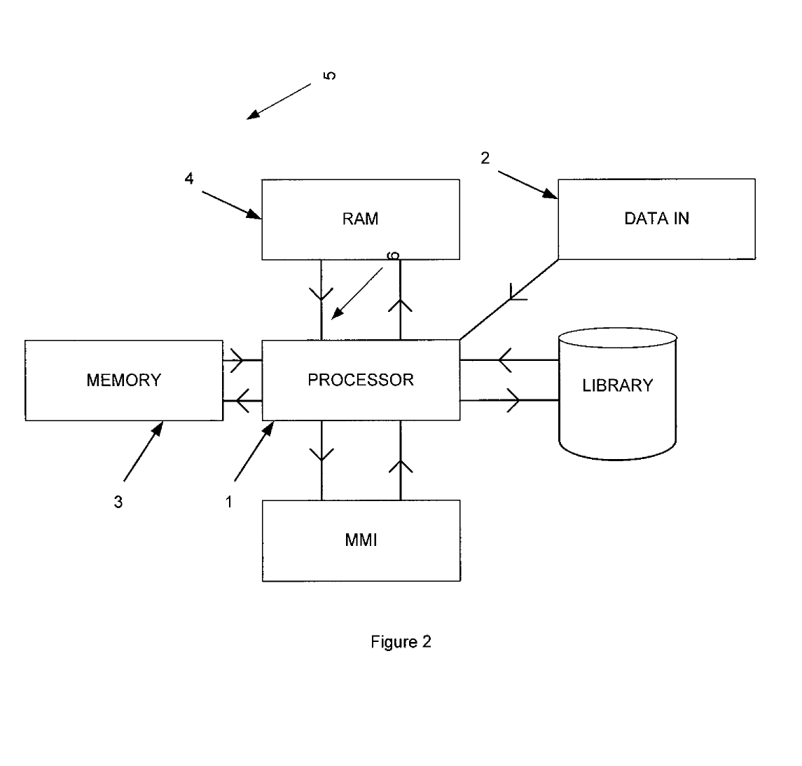

Referring to FIG. 2, the invention is conveniently realized as a computer system suitably programmed with instructions for carrying out the steps of the method according to the invention.

For example, a central processing unit 1 is able to receive data representative of a scan via a port 2 which could be a reader for portable data storage media (e.g. CD-ROM); a direct link with scanning apparatus (not shown) or a connection to a network.

Software applications loaded on memory 3 are executed to process the scan data in random access memory 4.

The system may include a further library of reference data 5 which may comprise an atlas of data used in the identification of landmarks.

A human machine interface 6 typically includes a keyboard/mouse combination (which allows user input such as initiation of applications and manual manipulation of partition boundaries) and a screen on which the results of executing the applications are displayed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method of dividing a scan into a series of partitions comprising:
in a processor placing a first estimate of predefined partition boundaries on the scan, updating the partition boundaries in the processor in accordance with the locations of key landmarks derived from the scan, and
displaying an image of the subject at a display unit connected to the processor in a display format including data representative of the updated partition boundaries.

2. A method according to claim 1 comprising displaying said image including data representative of the updated partition boundaries by augmenting the scan with said data.

3. A method according to claim 1 comprising displaying said image including data representative of the updated partition boundaries by displaying a different image, registered with the scan, where the different image includes said data.

4. A method according to claim 1 comprising locating the landmarks automatically using an image atlas.

5. A method according to claim 1 comprising locating the landmarks manually.

6. A method according to claim 1 comprising performing the updates automatically according to the landmark positions.

7. A method according to claim 1 comprising performing the updates manually by user interaction.

8. A method according to claim 1 comprising employing a series of planes or non-planar surfaces as said partitions.

9. A method according to claim 1 comprising employing as said scan, an anatomical representation obtained with an imaging modality selected from the group consisting of MRI, CT, Ultrasound.

10. A method according to claim 1 comprising displaying the image of the subject is a functional representation of PET or SPECT.

11. An apparatus for dividing a scan into a series of partitions, comprising:
a processor that automatically electronically places a first estimate of predefined partition boundaries on a scan,
an updating unit that allows updating of the partition boundaries dependent on locations of anatomical landmarks derived from the scan, and
a display unit connected to said processor, said processor being configured to display an image of the subject including data representative of the updated partition boundaries.

12. A computer-readable medium encoded with programming instructions, said programming instructions causing a processor to:
place a first estimate of predefined partition boundaries on a scan;
update the partition boundaries in accordance with locations of anatomical landmarks derived from the scan; and
cause an image of the subject to be displayed that includes data representative of the updated partition boundaries.

13. A method for assigning boundaries of interest in a scan of a subject to spatial regions of the subject, comprising the steps of:
generating a first scan of a subject containing spatial regions of interest;
generating a second scan of the subject, selected from the group consisting of scans that are different from said first scan and scans that are the same as said first scan, and identifying landmark features in said second scan;
defining at least on region boundary in relation to the landmark features identified in said second scan; and
automatically electronically assigning features of interest to regions defined by the region boundaries.

14. A method as claimed in claim 13 comprising displaying an image representing said first scan, augmented to include an indication of the region boundaries.
